(19) United States
(12) Patent Application Publication
(10) Pub. No.: US 2010/0053487 A1
(43) Pub. Date: Mar. 4, 2010

(54) LCD PANEL

(76) Inventors: Hung-Chang Wu, Tainan County (TW); Chin-Lung Ma, Taoyuan County (TW); Shih-Jung Huang, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/344,595

(22) Filed: Dec. 29, 2008

(30) Foreign Application Priority Data
Sep. 4, 2008 (TW) 097133882

(51) Int. Cl. G02F 1/136

(52) U.S. Cl. 349/42

(57) ABSTRACT

An LCD panel includes a group of data pads. The group of data pads includes at least a Vcom pad and a switch pad. The Vcom pad includes a first part and a second part. The switch pad includes a semiconductor layer connected between the first part and the second part. The first pad is coupled to the semiconductor layer, but formed on a different layer from the semiconductor layer. The semiconductor layer can be turned on by a voltage on the first pad, thereby turning on the Vcom pad.

### BACKGROUND OF THE INVENTION

1. Field of the Invention

The present invention relates to an LCD panel, and more particularly, to an LCD panel capable of providing data pads and Vcom pads with different signals.

2. Description of the Prior Art

Transversely crossing wires is generally not allowed when designing pad layout for liquid crystal display (LCD) panels. Therefore, common voltage (Vcom) pads are disposed at the first and last IC of data pads. Reference is made to FIG. 1 for a design diagram of pad layout in a prior art LCD panel 1. The LCD panel 1 includes a display region 100, a thin film transistor (TFT) 10, a liquid crystal capacitor 19, a storage capacitor 20, data pad groups 11-18, and gate-driving pad groups 21-24. The source of the TFT 10 is electrically connected to a data pad in the data pad group 11 via a data line 41. The gate of the TFT 10 is electrically connected to a gate-driving pad in the gate-driving pad group 21 via a gate line 42. The liquid crystal capacitor 19 and the storage capacitor 20 are coupled in parallel between a first node and a second node. The drain of the TFT 10 is electrically connected to the first node, and Vcom is applied to the second node. Similar to TFT 10, the display region 100 also includes a plurality of TFTs (not shown in FIG. 1), each having a source electrically connected to a corresponding data pad in the data pad group 11 via a corresponding data line, a gate electrically connected to a corresponding gate-driving pad in the gate-driving pad group 21 via a corresponding gate line, and a drain electrically connected to a corresponding liquid crystal capacitor and a corresponding storage capacitor at a corresponding first node. The corresponding liquid crystal capacitor and the corresponding storage capacitor are coupled in parallel between the corresponding first node and a corresponding second node, to which Vcom is applied.

Reference is made to FIG. 2 for a partially-enlarged diagram of the data pad group 11 in FIG. 1. Among pads 26-36 illustrated in FIG. 2, pads 26-30 are driver IC pads V_{GG} and S/R for inputting driving signals, pads 31 and 32 are Vcom pads for supplying a common voltage to the storage capacitors of the LCD panel 1, while pads 33-36 are data pads S0-S3 for inputting data signals. In FIG. 2, the data pad 33 (S0) and the Vcom pad 32 are adjacent to each other.

During the manufacturing process, it is often required to test luminance and chrominance of an LCD panel. Due to complicated module assembly procedures, simple test methods that do not require assemble the whole LCD module are need. In a conventional test method, voltages are applied to a plurality of probes each connected to a plurality of corresponding data pads. This method requires a large number of probes for luminance and chrominance measurement. Since testers meeting such requirement are very expensive, this conventional method largely increases manufacturing costs of the LCD panel, and is far from practical in mass production.

Another conventional test method utilizes an external light-up technique and is commonly applied to two-sided COG (Chip On Glass) and WOA (Wiring On Array) ICs. After covering the data pads of an LCD panel with a large piece of conductive rubber, adequate voltages are externally applied to the data pads via the conductive rubber, thereby lighting up the TFTs of the LCD panel for testing luminance and chrominance. As mentioned previously, Vcom pads and data pads are adjacent to each other in the panel layout. Conductive rubber also has high deformation ability. Therefore, extremely high accuracy is required when performing the external light-up technique for covering the data pads with the conductive rubber without contacting Vcom pads. With increase in LCD panel size and in pad layout and dramatic shrinkage in pad dimension, the external light-up technique encounters more and more difficulty when it comes to accuracy and success rate.

### SUMMARY OF THE INVENTION

The present invention provides an LCD panel comprising a plurality of TFTs, each electrically connected to a corresponding data line and a corresponding gate line; a plurality of data pad groups, each comprising: at least a Vcom pad having a first part and a second part, and electrically connected to a TFT of the plurality of the TFTs; a switch pad electrically connected between the first and second parts of the Vcom pad; and a plurality of data pads electrically connected to the data line of each corresponding TFT of the plurality of the TFTs; and a plurality of gate-driving pad groups, each comprising a plurality of gate-driving pads, wherein each gate-driving pad is electrically connected to the corresponding gate line.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a design diagram of pad layout in a prior art LCD pane.

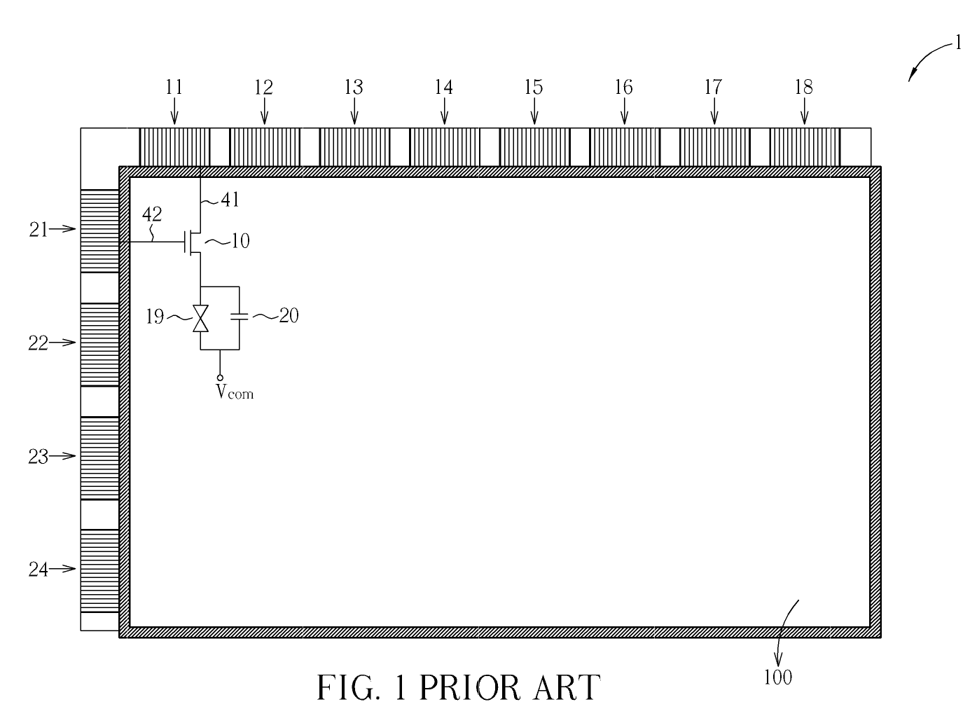

FIG. 2 is a partially-enlarged diagram of a prior art data pad group.

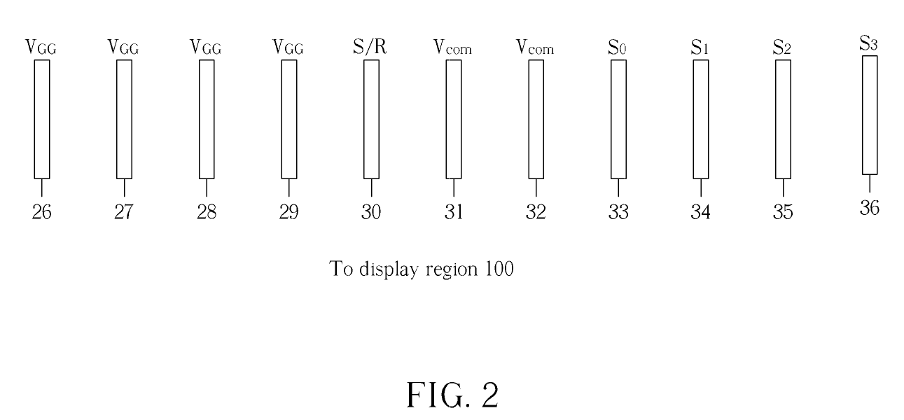

FIG. 3 is a schematic diagram of a Vcom pad according to the present invention.

FIG. 4 is a design diagram of pad layout in an LCD panel according to the present invention.

FIG. 5 is a partially-enlarged diagram of the data pad group in FIG. 4.

FIG. 6 is a diagram illustrating an external light-up technique according to the present invention.

### DETAILED DESCRIPTION

In order to solve the problems mentioned above, the present invention provides an LCD panel capable of providing data pads and Vcom pads with different signals when performing external light-up technique.

Certain terms are used throughout the following description and claim to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “electrically connect” and “electrically connects” are intended to mean either an indirect or a direct electrical connection. Thus, if a first device is electrically connected to a second device, that connection may be through a direct electrical connection, or through an indirect electrical connection via other devices and connections.

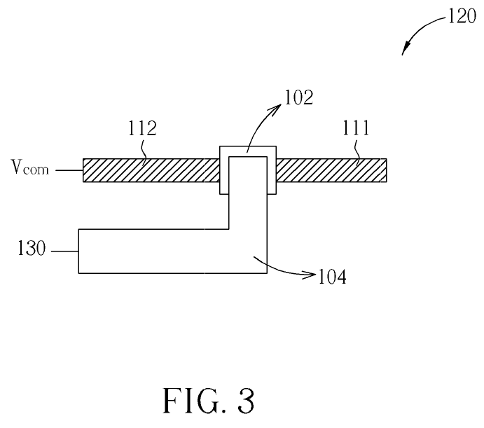

Reference is made to FIG. 3 for a schematic diagram of a Vcom pad 120 according to the present invention. A Vcom pad 120, a switch pad 130 having a semiconductor layer 102 and a first pad 104, a first part 111 and a second part 112 are depicted in FIG. 3. The semiconductor layer 102 of the switch pad 130 is connected between the first part 111 and the second part 112 of the Vcom pad 120. The first pad 104 of the switch pad 130 is connected to the semiconductor layer 102 of the switch pad 130. However, the first pad 104 and the semiconductor layer 102 are formed on different layers. Note that the driving circuit of an LCD panel usually has multiple layers, such as an SD layer and a GE layer. Data pads and the first pad 104 of the switch pad 130 are normally formed on SD layer. The Vcom pad 120 is usually formed on GE later. The semiconductor layer 102 of the switch pad 130 is formed on SE layer. Referring to FIG. 3, since the semiconductor layer 102 is connected between the first part 111 and the second part 112, the Vcom pad is short-circuited when the semiconductor layer 102 is conducting, and is open-circuited when the semiconductor layer 102 is not conducting. Though formed on different layers, the semiconductor layer 102 is connected to the first pad 104 of the switch pad 130. Therefore, when the voltage applied to the first pad 104 of the switch pad 130 exceeds a certain value, the semiconductor layer 102 is turned on, thereby short-circuiting the first part 111 and the second part 112 of the Vcom pad 120; when the voltage applied to the first pad 104 of the switch pad 130 is smaller than a certain value, the semiconductor layer 102 is turned off, thereby open-circuiting the first part 111 and the second part 112 of the Vcom pad 120.

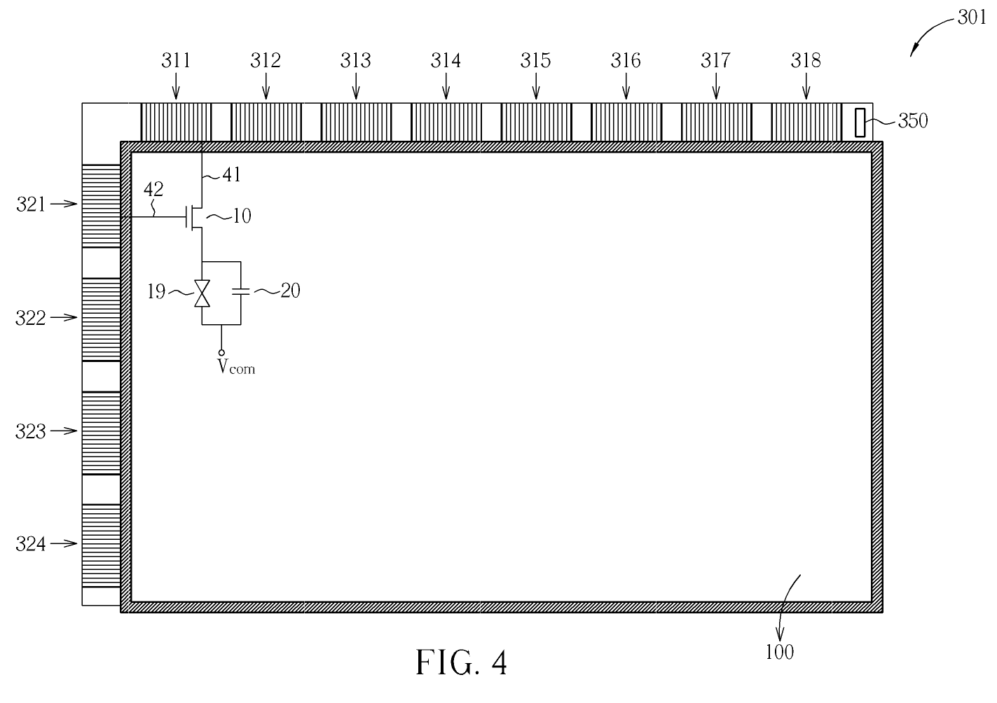

Reference is made to FIG. 4 for a design diagram of pad layout in an LCD panel 301 according to the present invention. The LCD panel 301 includes a display region 100, a TFT 10, a liquid crystal capacitor 19, a storage capacitor 20, data pad groups 311-318, gate-driving pad groups 321-324, and a testing Vcom pad 350. The source of the TFT 10 is electrically connected to a data pad in the data pad group 311 via a data line 41. The gate of the TFT 10 is electrically connected to a gate-driving pad in the gate-driving pad group 321 via a gate line 42. The liquid crystal capacitor 19 and the storage capacitor 20 are coupled in parallel between a first node and a second node. The drain of the TFT 10 is electrically connected to the first node, and Vcom is applied to the second node. Similar to TFT 10, the display region 100 also includes a plurality of TFTs (not shown in FIG. 4), each having a source electrically connected to a corresponding data pad via a corresponding data line, a gate electrically connected to a corresponding gate-driving pad via a corresponding gate line, and a drain electrically connected to a corresponding liquid crystal capacitor and a corresponding storage capacitor at a corresponding first node. The corresponding liquid crystal capacitor and the corresponding storage capacitor are coupled in parallel between the corresponding first node and a corresponding second node, to which Vcom is applied. The testing Vcom pad 350 is electrically connected to all second nodes in the display region 100.

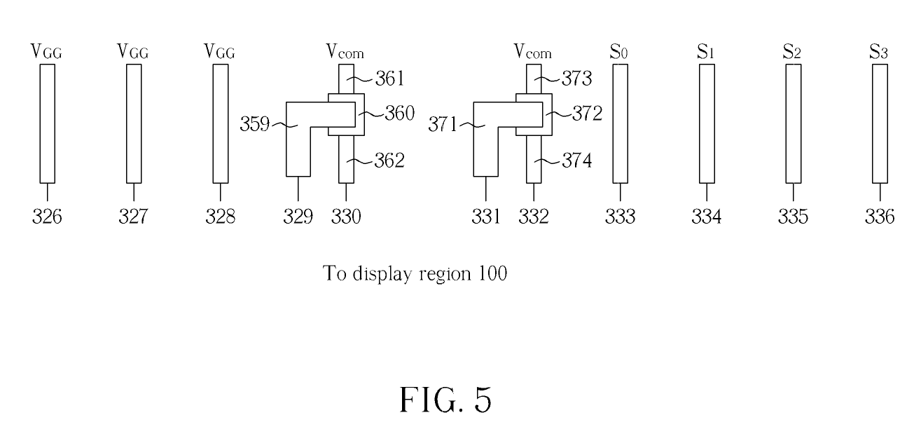

Reference is made to FIG. 5 for a partially-enlarged diagram of the data pad group 311 in FIG. 4. Among pads 326-336 illustrated in FIG. 5, pads 326-328 are driver IC pads V_{GG} for inputting driving signals, pads 330 and 332 are Vcom pads for supplying a common voltage to the storage capacitors of the LCD panel 301, pad 329 is a switch pad electrically connected to the Vcom pad 330 for turning on or turning off the Vcom pad 330, pad 331 is a switch pad electrically connected to the Vcom pad 332 for turning on or turning off the Vcom pad 332, while pads 333-336 are data pads S0-S3 for inputting data signals. In FIG. 5, the data pad 333 (S0) and the Vcom pad 332 are adjacent to each other. The Vcom pad 330 includes a first part 361 and a second part 362. The Vcom pad 332 includes a first part 373 and a second part 374. The switch pad 329 includes a first pad 359 and a semiconductor layer 360. The semiconductor layer 360 is connected between the first part 361 and the second part 362 of the Vcom pad 360. The first pad 359 is connected to the semiconductor layer 360. However, the first pad 359 and the semiconductor layer 360 are formed on different layers. Similarly, the Vcom pad 332 includes a first part 373 and a second part 374. The switch pad 331 includes a first pad 371 and a semiconductor layer 372. The semiconductor layer 372 is connected between the first part 373 and the second part 374 of the Vcom pad 332. The first pad 371 is connected to the semiconductor layer 372. However, the first pad 371 and the semiconductor layer 372 are formed on different layers.

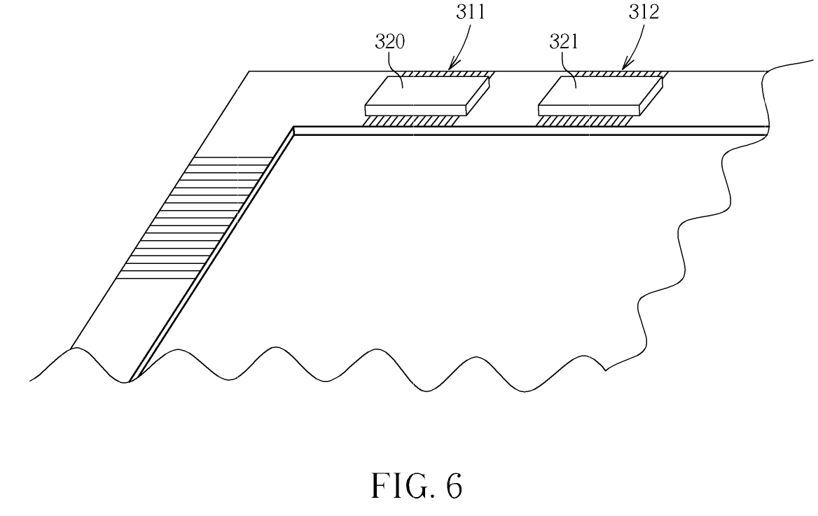

Reference is made to FIG. 6 for a diagram illustrating an external light-up technique according to the present invention. In FIG. 6, a conductive rubber 320 is disposed on all pads in the data pad group 311, and a conductive rubber 321 is disposed on all pads in the data pad group 312. In other words, the conductive rubber 320 simultaneously covers V_{GG} pads 326-328, data pads 333-336, Vcom pad 330, 332, and switch pads 329, 331. All pads in the data pad group 311 can thus receive test signals by applying voltages to the conductive rubber 320. When performing the external light-up technique, V_{GG} pads 326-328 have not been connected and thus do not respond to input signals. However, data pads and Vcom pads require different test signals. Due to soft material and high deformation ability of the conductive rubber 320, together with fine dimension between pads, the conductive rubber 320 can not be accurately controlled for covering the data pads without contacting other pads. In order to distinguish between test signals inputted to the Vcom pads and the data pads, a Vcom pad adjacent to a data pad is turned off via a corresponding switch pad, and receives test signals from the testing Vcom pad 350 depicted in FIG. 4 when performing the external light-up technique. All data pad groups 311-318 includes two Vcom pads for increasing layout flexibility and avoiding undesirable wire-crossing. On the other hand, since the testing Vcom pad 350 is located at the periphery of the LCD panel 301 away from the data pad groups, layout issues do not have to be taken into considerations. Therefore, only one testing Vcom pad 350 is required for supplying common voltages to all storage capacitors of the LCD panel 301.

The Vcom pad 330 and the switch pad 329 are used for illustrating the present invention (similar methods can be applied to the Vcom pad 332 and the switch pad 331). As mentioned previously, the Vcom pad 330 is short-circuited when the semiconductor layer 360 of the switch pad 329 is conducting, and is open-circuited when the semiconductor layer 360 is not conducting. The voltage level at the first pad 359 of the switch pad 329 determines whether the semiconductor layer 360 is conducting or not. The voltage applied to the conductive rubber 320 covering the switch pad 329 is also applied to the first pad 359 of the switch pad 329. When the applied voltage is larger than a threshold voltage, the semiconductor layer 360 is turned on, thereby short-circuiting the first part 361 and the second part 362 of the Vcom pad 330; when the applied voltage is smaller than the threshold voltage, the semiconductor layer 360 is turned on, thereby open-circuiting the first part 361 and the second part 362 of the Vcom pad 330. For an LCD panel with 3-volt full driving design, the voltage level of data signals ranges between Vcom±3, and can not exceed the threshold voltage to avoid turning on the Vcom pad. Under this circumstance, the threshold voltage must be set to a level higher than Vcom+3. For an LCD panel with 5-volt full driving design, the voltage level of data signals ranges between Vcom±5, and the threshold voltage must be set to a level higher than Vcom+5.

In the present invention, spare pads in the IC are used for designing the switch pads. The first pad of each switch pad must be formed on different levels from its corresponding Vcom pad, to which the first pad is electrically connected. In the present invention, a switch pad can be disposed adjacent to a corresponding Vcom pad controlled by the switch pad, or on a spare pad located further away. In the later case, layout issues must be taken into consideration to avoid influencing other circuits. In the above-mentioned embodiments, 8 data pad groups and 4 gate-driving pad groups are used for illustrating the present invention. However, the present invention can also be applied to other numbers of data pad groups and gate-driving pad groups. The present invention can be applied when performing external light-up technique. The Vcom pads in the data pad groups are turned off and receive common voltages from a testing Vcom pad (such as testing Vcom pads 330 and 332 in FIG. 5) instead. For conducting the Vcom pads 330 and 332, the voltage applied to the switch pads 329 and 331 must be larger than a threshold voltage.

The present invention provides an LCD panel capable of providing data pads and Vcom pads with different signals when performing external light-up technique. Parameters such as luminance and chrominance of the LCD panel can thus be measured during the manufacturing process.

Those skilled in the art will readily observe that numerous modifications and alterations of the device and method may be made while retaining the teachings of the invention.

What is claimed is:

1. A liquid crystal display (LCD) panel, comprising:
a plurality of thin film transistors (TFTs), each electrically connected to a corresponding data line and a corresponding gate line;
a plurality of data pad groups, each comprising:
at least a common voltage (Vcom) pad having a first part and a second part, and electrically connected to a TFT of the plurality of the TFTs;
a switch pad electrically connected between the first and second parts of the Vcom pad; and
a plurality of data pads electrically connected to the data line of each corresponding TFT of the plurality of the TFTs; and
a plurality of gate-driving pad groups, each comprising a plurality of gate-driving pads, wherein each gate-driving pad is electrically connected to the corresponding gate line.

2. The LCD panel of claim 1, wherein the switch pad includes:
a semiconductor layer connected between the first and second parts of the Vcom pad; and
a first pad electrically connected to the semiconductor layer, wherein the first pad and the semiconductor layer are formed on different layer.

3. The LCD panel of claim 1, wherein the Vcom pad is turned on or turned off base on a status of the semiconductor layer of the switch pad.

4. The LCD panel of claim 3, wherein the status of the semiconductor layer is determined by a voltage applied to the first pad of the switch pad.

5. The LCD panel of claim 1 further comprising a testing Vcom pad electrically connected to common voltage nodes of the plurality of TFTs.
